(19) United States
(12) Patent Application Publication
(10) Pub. No.: US 2025/0184696 A1
(43) Pub. Date: Jun. 5, 2025

(54) CONCURRENT USER ACCESS TO MULTIPLE PRIVATE GROUPS IN A NETWORK

(71) Applicant: Cisco Technology, Inc., San Jose, CA (US)

(72) Inventors: Shree Narasimha Murthy, San Jose, CA (US); Srinath Gundavelli, San Jose, CA (US); Stephen Michael Orr, Wallkill, NY (US); Pradeep Kumar Kathail, Los Altos, CA (US)

(21) Appl. No.: 18/525,421

(22) Filed: Nov. 30, 2023

(51) Int. Cl. H04W 4/08; H04W 12/06

(52) U.S. Cl. CPC H04W 4/08; H04W 12/06

(57) ABSTRACT

This disclosure describes techniques and mechanisms for enabling an end point to have concurrent access to multiple private groups within a network. For instance, the private groups may correspond to user defined network (UDN) groups. The techniques described herein include mapping identifiers (e.g., device identifiers, flowlabels, application identifiers, UDN group identifiers, etc.). The techniques enable a user device to access a first UDN group using a first application on the user device and a second UDN group using a second application on the user device, such that a user does not have to leave the first UDN group in order to participate in the second UDN group. Moreover, the assignment of a user device to one or more UDN groups is policy driven and the infrastructure ensures that only the relevant data traffic is forwarded to the group members within a particular UDN group.

### TECHNICAL FIELD

The present disclosure relates generally to the field of networking, and more particularly to techniques for allowing a user to participate in multiple private user defined network (UDN) groups simultaneously.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches act as controllers that allow devices in a network to communicate with each other. Routers connect multiple networks together, and also connect computers on those networks to the Internet, by acting as a dispatcher in networks by analyzing data being sent across a network and choosing an optimal route for the data to travel. Access points act like amplifiers for a network and serve to extend the bandwidth provided by routers so that the network can support many devices located further distances from each other.

Within the networks, user defined networks (UDNs) may be offered. A UDN is a construct in the enterprise networks for creating logical private groups. The UDN concept is about allowing an end-user to create a private network, which helps in limiting scope for service-discovery, realizing traffic segmentation, and enforcing access controls at the group level. The ability for a user to identify a set of client devices, for creating a trusted private group is the key outcome.

Currently, users have the ability to create their own UDN in a shared environment. For instance, an end user may manually configure a UDN using an application, self-registering with a cloud service, or through a policy engine. When creating the UDN, the end user registers the identity (e.g., MAC addresses) of the user(s) and devices that may access and/or communicate with the UDN. The cloud service may assign a unique identity to the new UDN group and the unique identifier is then communicated to the infrastructure to enforce segmentation and traffic containment policies within the network. Users and devices may switch between UDN groups through an explicit invite and accept workflow, where the invite and accept workflow is initiated each time a user and/or device access the UDN group and/or tries to switch to a new UDN group. Further, current techniques allow an endpoint (e.g., a device of a user) to participate in one UDN group at a time, such that if the user wants to participate in a new UDN group with the same device, the user must leave the first UDN group and join the new UDN group. Thus, restricting access to a single private group may be limiting and cumbersome to users.

Accordingly, there is a need to improve infrastructure to enable a device of a user to access multiple private groups concurrently.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagrams of an environment in which concurrent access of an end point to multiple private UDN groups is supported.

FIGS. 2A and 2B illustrate a flow diagram of example communications corresponding to enabling an endpoint to have concurrent access to multiple private UDN groups.

FIGS. 3A and 3B illustrate a flow diagram of example communications corresponding to enabling an endpoint to have concurrent access to multiple private UDN groups.

FIG. 4 illustrates a flow diagram of an example method for a system to enable concurrent access to multiple private UDN groups.

FIG. 5 illustrates a flow diagram of an example method for a device to access multiple private UDNs concurrently.

FIG. 6 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

The present disclosure relates generally to techniques for performing UDN service authorization based on secondary identity credentials.

A method to perform techniques described herein, where the method may be implemented by a controller of a wireless network. In some examples, the method includes receiving, from a device of a user, first data packets associated with a first application executing on the device, the first data packets comprising a first identifier and a device identifier. In some examples, the method includes identifying, based at least in part on the first identifier, a first user defined network (UDN) group within the wireless network, the first UDN group comprising one or more second devices of the user. The method further includes applying, based at least in part on a first UDN identifier associated with the first UDN group, one or more policies to the first data packets. The method also includes sending, based at least in part on the one or more policies, the first data packets to each of the one or more second devices in the first UDN group.

Another method to perform techniques described herein may be implemented by a device of a user. The method may include receiving first data, the first data comprising a first mapping of a first application to a first identifier, wherein the first application is associated with a first UDN group. The method may include receiving first input associated with the first application. Based on receiving the first input, the method may include generating first data packets, the first data packets comprising a device identifier associated with the device and the first identifier. The method may further include sending, to a controller of the network, the first data packets.

Additionally, the techniques described herein may be performed by a system and/or device having non-transitory computer-readable media storing computer-executable instructions that, when executed by one or more processors, performs the method described above.

### Example Embodiments

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches act as controllers that allow devices in a network to communicate with each other. Routers connect multiple networks together, and also connect computers on those networks to the Internet, by acting as a dispatcher in networks by analyzing data being sent across a network and choosing an optimal route for the data to travel. Access points act like amplifiers for a network and serve to extend the bandwidth provided by routers so that the network can support many devices located further distances from each other.

Within the networks, user defined networks (UDNs) may be offered. A UDN is a construct in the enterprise networks for creating logical private groups. The UDN concept is about allowing an end-user to create a private network, which helps in limiting scope for service-discovery, realizing traffic segmentation, and enforcing access controls at the group level. The ability for a user to identify a set of client devices, for creating a trusted private group is the key outcome.

Currently, users have the ability to create their own UDN in a shared environment. For instance, an end user may manually configure a UDN using an application, self-registering with a cloud service, or through a policy engine. When creating the UDN, the end user registers the identity (e.g., MAC addresses) of the user(s) and devices that may access and/or communicate with the UDN. The cloud service may assign a unique identity to the new UDN group and the unique identifier is then communicated to the infrastructure to enforce segmentation and traffic containment policies within the network. Users and devices may switch between UDN groups through an explicit invite and accept workflow, where the invite and accept workflow is initiated each time a user and/or device access the UDN group and/or tries to switch to a new UDN group. Further, current techniques allow an endpoint (e.g., a device of a user) to participate in one UDN group at a time, such that if the user wants to participate in a new UDN group with the same device, the user must leave the first UDN group and join the new UDN group. Thus, restricting access to a single private group may be limiting and cumbersome to users.

Accordingly, there is a need to improve infrastructure to enable a device of a user to access multiple private groups concurrently.

This disclosure describes techniques and mechanisms for enabling a user device to concurrently participate in multiple private UDN groups. For instance, the techniques may be implemented by a controller of a network. In some examples, the techniques may include receiving, from a device of a user, first data packets associated with a first application executing on the device, the first data packets comprising a first identifier and a device identifier. In some examples, the techniques include identifying, based at least in part on the first identifier, a first user defined network (UDN) group within the network, the first UDN group comprising one or more second devices of the user. In some examples, the techniques further include applying, based at least in part on a first UDN identifier associated with the first UDN group, one or more policies to the first data packets. The techniques may also include sending, based at least in part on the one or more policies, the first data packets to each of the one or more second devices in the first UDN group.

Additionally, the techniques may be implemented by a device of a user. The techniques may comprise receiving first data, the first data comprising a first mapping of a first application to a first identifier, wherein the first application is associated with a first UDN group. The techniques may include receiving first input associated with the first application. Based on receiving the first input, the techniques may include generating first data packets, the first data packets comprising a device identifier associated with the device and the first identifier. The techniques may further include sending, to a controller of the network, the first data packets.

In some examples, the data packets may further comprise an application identifier associated with the application, a device identifier associated with device, or any other data. In some examples, the first identifier may comprise a flowlabel (e.g., such as an IPV6 flowlabel). In some examples, and as described in greater detail below, the flowlabel can be mapped to the application.

In some examples, applying the one or more policies includes identifying traffic enforcement and containment policies. may identify a UDN group and traffic enforcement policies. In some examples, the controller may determine a UDN group identifier based on mapping a device identifier of the user device and the flowlabel. For instance, the controller 110 may determine that the flowlabel included in the first data packet(s) from the first application is associated with UDN group 1. In this example, the controller may identify one or more policies associated with UDN group 1 based on the UDN group identifier. For instance, the one or more policies may include determining that the first data packet(s) are being sent to a device that is included in UDN group 1. Where the destination device is not included in UDN group 1, the controller may refrain from sending the first data packet(s) to the device(s) included in UDN group 1. For instance, the controller may store list(s) of authenticated device(s) and corresponding UDN group(s) in memory. In some examples, such as where the destination device is included in the device(s) of UDN group 1, the controller may determine that the one or more policies may include traffic containment policies such that the first data packet(s) and/or any data packet(s) that include the flowlabel associated with UDN group 1 are sent only to the device(s) included in UDN group 1.

In some examples, such as where the controller has received second data packet(s) comprising a second flowlabel, the controller may identify a second UDN group identifier based at least in part on the second flowlabel. For instance, the second flowlabel may be mapped to UDN group 2. In this example, the controller may identify second policies associated with UDN group 2. In some examples, such as where the controller determines that a destination device of the second data packet(s) is included in the device(s) of UDN group 2, the controller may determine that the one or more policies may include traffic containment policies such that the second data packet(s) and/or any data packet(s) that include the second flowlabel associated with UDN group 2 are sent only to the device(s) included in UDN group 2.

In this way, an end user may be part of two or more private groups at the same time. By not having to leave a first UDN group and join a second UDN group, the current techniques improve UDN infrastructure and reduce network usage, improving the functioning of the network. Moreover, by only sending traffic to device(s) within a particular UDN group, network traffic is streamlined. Further, the techniques described herein enable access to the private group (e.g., UDN group) to be based on application. This enables users to have application based segmentation and enables the network infrastructure to enforce different application based policies and SLAs accordingly. Additionally, the techniques described herein provide users the ability to have disjoint set of groups (destinations) depending on which application is being used.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

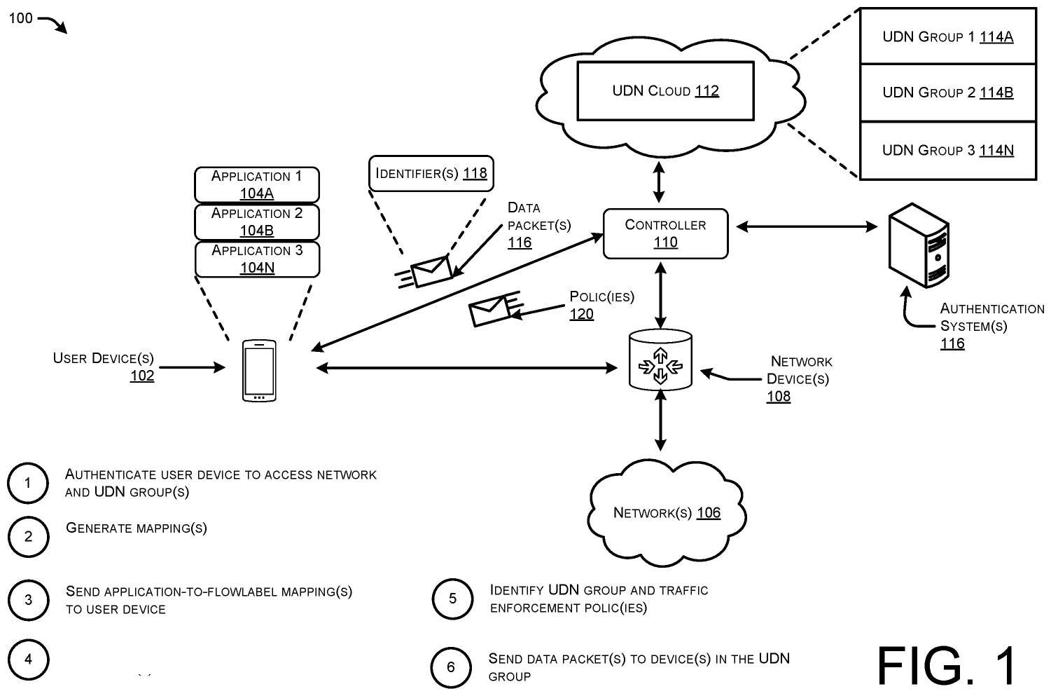

FIG. 1 illustrates a system-architecture diagrams of an environment 100 in which concurrent access of an end point to multiple private UDN groups is supported. In some examples, the environment 100 may include a user device 102 (e.g., an end point). The user device(s) 102 may include one or more device(s), and may comprise any computing device, such as a mobile device, a laptop, a computer, a tablet, any Wi-Fi enabled device, any cellular enabled device, and/or any Bluetooth enabled device. In some examples, the user device 102 may correspond to a device of an administrator (not shown). In some examples, the user device 102 may correspond to a device of an end user. The user device 102 may include one or more application(s) 104. In some examples, the application 104 may correspond to a UDN application that enables a user of the user device 102 to access network(s) 106, create UDN network(s), etc. In some examples, a first application 104A may be associated with a first UDN group 114A. For instance, the first application 104A may be associated with accessing the first UDN group 114A and a second application 104B may be associated with accessing a second UDN group 114B. In some examples, the first application 104A and second application 104B comprise different applications.

In some examples, the user device 102 may communicate with one or more of a controller 110 and/or network device 108 in order to access network(s) 106. Networks 106 may include any combination of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. In some examples, the network(s) 106 may correspond to a private enterprise network, a cellular network (e.g., such as a 5g network), or any other type of network.

The user device(s) 102 and/or network device(s) 108 may communicate using any type of protocol over the network(s) 106, such as the transmission control protocol/Internet protocol (TCP/IP) that is used to govern connects to and over the Internet.

In some examples, the network(s) 106 may corresponds to a service network that includes devices housed or located in one or more data centers. The service network may include one or more networks implemented by any viable communication technology, such as wired and/or wireless modalities and/or technologies. The service network may include any combination of Personal Area Networks (PANs), Local Area Networks (LANs), Wireless LANs, Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed—and/or any combination, permutation, and/or aggregation thereof. The service network may include devices, virtual resources, or other nodes that relay packets from one network segment to another by nodes in the computer network. The service network may include multiple devices that utilize the network layer (and/or session layer, transport layer, etc.) in the OSI model for packet forwarding, and/or other layers.

The one or more data centers may be physical facilities or buildings located across geographic areas that designated to store networked devices that are part of a manufacturer. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the packet-forwarding networks may not be located in explicitly defined data centers, but may be located in other locations or buildings.

In some examples, network device(s) 108 correspond to any computing device, routers, switches, computers, or any other type of network device. In some examples, the network device(s) 108 may comprise an access point. For instance, as illustrated in FIG. 1, the user device 102 may be connected to the network(s) 106 via an access point, such as via network device(s) 108. In some examples, the network device(s) 108 may be separate from the controller 110. In some examples, the controller 110 and the network device(s) 108 may be part of a same device. In some examples, the network device(s) 108 may include mobile device management (MDM) functionality.

In some examples, the controller 110 may comprise a computing device, processor(s), memory, etc. For instance, the controller 110 may correspond to a Cisco IOS based Catalyst Series physical wireless LAN controller (WLC) or a virtual WLC. In some examples, the controller 110 may be included as part of one or more of the network device 108, authentication system 116, and/or UDN cloud 112.

In some examples, the controller 110 may be connected to and/or communicate with one or more authentication system(s) 116. In some examples, the authentication system 116 may include any website, database, server(s), computing device(s), or other service. The controller 110 may connect and/or access the authentication system 116 to initiate primary authentication and/or secondary authentication of the user device (e.g., such as via an EAP dialogue) and/or configure policy mappings. In some examples, the authentication system 116 corresponds to one or more authentication, accounting, and authorization (AAA) engines. In some examples, the authentication system(s) 116 may correspond to an AAA engine and/or a third-party authentication service. In some examples, the authentication system 116 may include mobile device management (MDM) functionality. In some examples, the authentication system 116 may be included as part of the network device 108 and/or the UDN cloud 112.

In some examples, the controller 110 may communicate with the UDN cloud 112 directly and/or indirectly. The UDN cloud 112 may comprise one or more UDN group(s) 114 within the network 106. For instance, the UDN cloud 112 may correspond to Cisco UDN Cloud. In some examples, a user may configure each UDN group 114. For instance, a user may configure UDN group 1 114A to include a first set of user device(s) 102 associated with gaming (e.g., gaming console, TV, headset, etc.). In this example, the user may configure UDN group 2 114B to include a second set of user device(s) 102 associated with school (e.g., printer, laptop, etc.). In some examples, the user may configure a first application 104A to be associated with UDN group 1 114A and a second application 104B to be associated with UDN group 2 114B.

In some examples, the user device(s) 102 are configured to send data packet(s) 116 to the controller 110 and/or network device(s) 108. In some examples, the data packet(s) may comprise identifier(s) 118. In some examples, the identifier(s) 118 include one or more flowlabel(s), a device identifier, an application identifier, and/or any other identifier. In some examples, the flowlabel(s) correspond to IPV6 flowlabels.

In some examples, the controller 110 and/or network device(s) 108 may be configured to send polic(ies) 120 to the user device(s) 102. For instance, the polic(ies) 120 may comprise application-to-flowlabel mappings. In some examples, the application-to-flowlabel mappings indicate an association between an application executing on the user device 102 and a flowlabel (e.g., “application, flowlabel”). In some examples, the polic(ies) 120 may comprise a plurality of application-to-flowlabel mappings.

At “1”, the controller 110 and/or network device 108 may authenticate a user device to access the network and/or UDN group(s) within the network. For instance, the user device 102 may communicate (e.g., send a request) with the network device 108 and/or controller 110 in order to access the network(s) 106 and/or UDN group(s) 114. In some examples, the request may comprise credentials (e.g., username, password, group identifier(s), etc.). In some examples, the network 106 may correspond to a Wi-Fi network available on a school campus. In this example, the request may comprise first credentials associated with accessing the Wi-Fi network. For instance, the controller 110 may perform access authentication using the first credentials associated with the Wi-Fi network. In some examples, the controller 110 may communicate with the authentication system 116 to authenticate the user device 102. For instance, where the first credentials comprise a username and password, the controller 110 may communicate with an authentication system to determine whether the username and password match those stored in a database. Once primary access authentication is complete, the user device 102 may access the Wi-Fi network. In some examples, the controller may perform secondary authentication using secondary credentials sent by the user device. The second request may comprise second credentials. The second credentials may be associated with the UDN group. For instance, the second credentials may comprise a group identifier of the UDN group, a password associated with the UDN group, or any other credential. In some examples, the second request may comprise an EAP identity/request message that includes the second credentials. In some examples, the controller 110 may establish a secondary EAP dialogue with the user device in order to authenticate the second credentials. In some examples, the user device 102 may authenticate additional credentials to access additional UDN group(s). Once authenticated the controller 110 may add the user device to the UDN group(s), such that the user device has access to the UDN group (e.g., UDN group 1 and/or UDN group 2).

In some examples, such as where the network 106 is associated with a school, UDN group 1 114A may be associated with a first group of user device(s) 102 of a user (e.g., gaming device(s), such as a gaming console, a TV, etc.) and UDN group 2 114B may be associated with a second set of user device(s) 102 of the user (e.g., such as school device(s) such as a printer, a laptop, etc.).

In some examples, the user device 102 is assigned to one or more UDN groups upon device registration to the UDN cloud, based on the type of device and/or pre-defined policies. In some examples, the UDN group assignments are mapped to flow labels which the user device 102 can use to send data traffic on specific sessions. As described in greater detail below, these mapping are pushed to the user device 102 as policies. The described infrastructure may deliver the policies to user device securely using one or more mechanisms including MDM, access authentication, and/or DPP extension to support private group assignments.

At “2”, the controller 110, network device 108, and/or authentication system 116 may generate mapping(s). In some examples, the mapping(s) are generated to map application(s) to flowlabel(s). For instance, the mapping(s) may correspond to policy configurations and may include traffic enforcement rules. In some examples, the traffic enforcement rules may indicate to segment traffic based on a UDN group associated with a particular application-to-flowlabel mapping. For instance, Application 1 104A on the user device 102 may be associated with UDN Group 1 114A. In this example, the mapping may associate an application identifier of Application 1 104A to a first identifier (e.g., a flowlabel, such as an IPV6 flowlabel). In some examples, the first flowlabel is associated with UDN Group 1.

In some examples, upon registration and authorization of the user device 102, policies are also pushed to the enforcement point in the network infrastructure (e.g., the controller 110) to map the defined user device's 102 flowlabels to specific private group identifiers (as part of the authorization policy upon onboarding the user device 102 to the network 106).

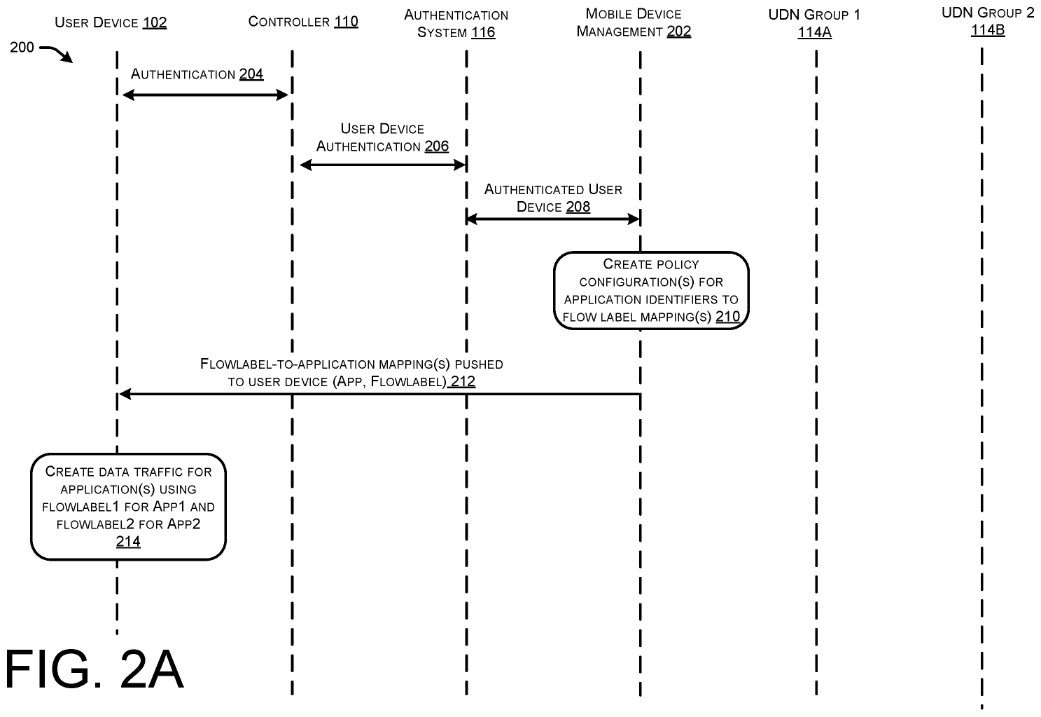

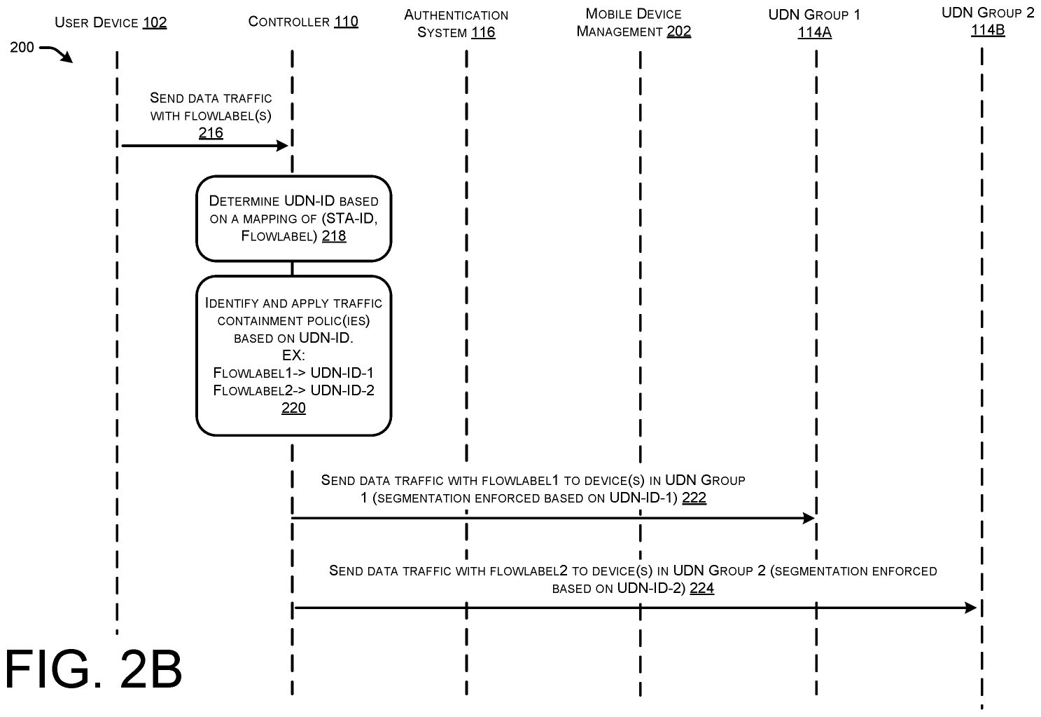

At “3”, the controller 110 and/or network device 108 may send application to flowlabel mapping(s) to the user device 102. In some examples, the controller 110 may receive the application to flowlabel mapping(s) from the authentication system 116. For instance, the authentication system 116 may send data including a device identifier of the user device 102, one or more flowlabel(s), one or more application identifier(s), and/or one or more UDN group identifier(s)). In this example, the controller 110 may forward to the user device 102 the application identifier and flowlabel. As described in greater detail below with regard to FIGS. 2A and 2B, in some examples, the user device 102 may receive the application to flowlabel mapping from the network device 108 and/or the authentication system 116. For instance, where the network device 108 and/or authentication system 116 includes a mobile device management (MDM) functionality, the mobile device management may create policy configuration(s) that include the application to flowlabel mapping(s) and may push the application to flowlabel mapping(s) (e.g., the application identifier and flowlabel) directly to the user device 102. In some examples, the mobile device management may correspond to a network device 108 and/or an application or functionality executing on the network device 108 and/or the authentication system 116.

At “4”, the controller 110 and/or network device 108 may receive data packet(s) comprising flowlabel(s). For instance, the controller 110 may receive first data packet(s) 116 associated with a first application 104A. In this example, when a user interacts with a particular application, the user device 102 may generate first data packet(s) 116 comprising the identifier 118. As noted above, the identifier 118 may correspond to a flowlabel associated (e.g., mapped) to the first application 104A. In some examples, the flowlabel may correspond to an IPV6 flowlabel. As noted above, the first data packet(s) may comprise additional data, including an application identifier, device identifier (e.g., such as MAC address, SSID, etc.), metadata associated with the application, and/or any other data. In some examples, the user device 102 may use the policies it receives from the controller 110 and/or MDM upon registration to assign and/or mark the data traffic associated with an application and/or session with the specified flowlabels.

In some examples, the controller 110 may receive second data packet(s) associated with the use of a second application 104B. In this example, the second data packet(s) may comprise a second identifier (e.g., a second flowlabel) that is associated and/or mapped to the second application. In some examples, the first application and the second application are different applications. In some examples, the first application and the second application may be associated with different UDN group(s) 114. In some examples, the first identifier is different from the second identifier.

At “5”, the controller 110 and/or network device 108 may identify a UDN group and traffic enforcement policies. In some examples, the controller 110 may determine a UDN group identifier based on mapping a device identifier of the user device 102 and the flowlabel. For instance, the controller 110 may determine that the flowlabel included in the first data packet(s) from the first application 104A is associated with UDN group 1 114A. In this example, the controller 110 may identify one or more policies associated with UDN group 1 114A based on the UDN group identifier. For instance, the one or more policies may include determining that the first data packet(s) are being sent to a device that is included in UDN group 1. Where the destination device is not included in UDN group 1, the controller 110 may refrain from sending the first data packet(s) to the device(s) included in UDN group 1 114A. For instance, the controller 110 may store list(s) of authenticated device(s) and corresponding UDN group(s) in memory. In some examples, such as where the destination device is included in the device(s) of UDN group 1 114A, the controller 110 may determine that the one or more policies may include traffic containment policies such that the first data packet(s) and/or any data packet(s) that include the flowlabel associated with UDN group 1 114A are sent only to the device(s) included in UDN group 1 114A.

In some examples, the controller 110 may map (device identifier, flow labels) tuples to UDN group identifiers (as defined by infrastructure authorization policies) and may enforce traffic containment/segmentation accordingly (e.g., such as by leveraging the existing mechanism for traffic containment).

In some examples, such as where the controller 110 has received second data packet(s) comprising a second flowlabel, the controller 110 may identify a second UDN group identifier based at least in part on the second flowlabel. For instance, the second flowlabel may be mapped to UDN group 2 114B. In this example, the controller 110 may identify second policies associated with UDN group 2. In some examples, such as where the controller 110 determines that a destination device of the second data packet(s) is included in the device(s) of UDN group 2 114B, the controller 110 may determine that the one or more policies may include traffic containment policies such that the second data packet(s) and/or any data packet(s) that include the second flowlabel associated with UDN group 2 114B are sent only to the device(s) included in UDN group 2 114B.

At “6”, the controller 110 and/or network device 108 may send the data packet(s) to device(s) in the UDN group. As noted above, the controller 110 may send the data packet(s) to the device(s) in a particular UDN group, where the controller 110 enforces segmentation based on the flowlabel and/or UDN group identifier. The controller 110 may send the data packet(s) via the network(s) 106 and/or any other network.

In this way, an end user may be part of two or more private groups at the same time. By not having to leave a first UDN group and join a second UDN group, the current techniques improve UDN infrastructure and reduce network usage, improving the functioning of the network. Moreover, by only sending traffic to device(s) within a particular UDN group, network traffic is streamlined.

FIGS. 2A and 2B illustrate a flow diagram of example communications 200 corresponding to enabling an endpoint to have concurrent access to multiple private UDN groups. For instance, the endpoint may correspond to user device 102 described above. As illustrated, the system may include a mobile device management (MDM 202). As noted above, the MDM 202 may correspond to a functionality. For instance, the MDM 202 may create policy configuration(s) that include the application to flowlabel mapping(s). In some examples, the mobile device management may correspond to a network device 108 and/or an application or functionality executing on the network device 108 and/or the authentication system 116. As described above, the controller 110 may comprise a WLC and/or an access point.

In some examples, the user of the user device may correspond to a student attempting to access private UDN group(s) the user has created within a school network. In this example, the UDN groups 114 may be included as part of the UDN cloud 112 described above. In some examples, the UDN groups 114 may be associated with groups of device(s) of the user. For instance, UDN group 1 114A may correspond to gaming device(s) (e.g., gaming console, TV, etc.) and UDN group 2 114B may correspond to school device(s) (e.g., laptop, printer, etc.).

As illustrated in FIG. 2A, at 204, the user device 102 may perform authentication with the controller 110. For instance, as described above, the user device 102 may send primary and/or secondary credentials to the controller 110 in order to access a network 106, create UDN group(s), and/or join a UDN group. For instance, the user device authentication may include performing EAP dialogue(s) with the user device.

At 206, the controller 110 may perform user device authentication with the authentication system 116. For instance, the controller 110 may authenticate the credential(s) provided by the user device 102.

As noted above, in some examples, the authentication system 116 may correspond to an external entity that manages only secondary credentials and/or secondary authentication of the user device. For instance, a first authentication system (e.g., such as an AAA engine) may handle primary access authentication of the user device at 216 and a second authentication system (e.g., such as an external entity), may handle the secondary authentication associated with the UDN group(s).

At 208, the authentication system 116 may send an indication that the user device 102 has been authenticated to the MDM 202. In some examples, the indication may comprise data including a device identifier of the user device 102, application identifier(s), UDN group identifier(s), etc.

At 210, the MDM 202 may create policy configuration(s) for application identifiers to flowlabel mapping(s). For instance, the MDM may create traffic enforcement polic(ies) associated with UDN group 1 114A and/or UDN group 2 114B. In some examples, the MDM 202 may generate flowlabel(s) and may map the flowlabel(s) to corresponding application(s) and UDN group(s). The MDM 202 may store the mapping(s) in memory and/or a server of the authentication system. In some examples, the MDM 202 updates a list of authenticated device(s) associated with UDN group 1 114A to include the user device 102 and/or updates the list of authenticated device(s) associated with UDN group 2 114B to include the user device 102.

At 212, the MDM 202 may push the application-to-flowlabel mapping(s) (e.g., the application identifier and flowlabel) directly to the user device 102. For instance, the MDM 202 may push a first mapping comprising a first application identifier and a first flowlabel. The MDM 202 may push a second mapping comprising a second application identifier and a second flowlabel. In some examples, the MDM 202 may push a data packet that comprises a plurality of mapping(s) between a plurality of application(s) and a plurality of flowlabel(s). In some examples, the user device 102 may store the flowlabel-to-application mapping(s) in memory.

At 214, the user device 102 may create data traffic for application(s) using flowlabel1 for application1 and flowlabel2 for application2. For instance, the user device 102 may create first data packets associated with the use of application1. Application1 may correspond to application 104A described above and may be associated with accessing UDN group 1 114A. The user device 102 may also create second data packets associated with the use of application2. Application2 may correspond to application 104B described above and may be associated with accessing UDN group 1 114B. The first data packets may comprise flowlabel1 and the second data packets may comprise flowlabel2. In some examples, flowlabel1 and flowlabel2 are different. In some examples, the user device 102 creates the first data packets based at least in part on accessing an application-to-flowlabel mapping for application1 and application2. For instance, the user device 102 may access a first application identifier associated with application1 and the corresponding flowlabel1 from memory.

As illustrated in FIG. 2B, at 216, the user device 102 may send the data traffic with the flowlabel(s) to the controller 110.

At 218, the controller 110 may determine a UDN-ID based on a mapping of a device identifier and flowlabel(s) included in the data traffic. For instance, the mapping may indicate a device identifier (e.g., STA-ID) and flowlabel1. Based on the mapping, the controller 110 may determine that the first data packets are destined for UDN-ID-1 (e.g., UDN group 1). For instance, a second mapping may indicate the device identifier (e.g., STA-ID) and flowlabel2. Based on the second mapping, the controller 110 may determine that the second data packets are destined for UDN-ID-2 (e.g., UDN group 2).

At 220, the controller 110 may identify and apply traffic containment policies based on UDN-ID(s). For instance, the controller 110 may identify one or more policies associated with UDN group 1 114A based on the UDN-ID-1. For instance, the one or more policies may include determining that the first data packet(s) are being sent to a device that is included in UDN group 1. Where the destination device is not included in UDN group 1, the controller 110 may refrain from sending the first data packet(s) to the device(s) included in UDN group 1 114A. For instance, the controller 110 may store list(s) of authenticated device(s) and corresponding UDN group(s) in memory. In some examples, such as where the destination device is included in the device(s) of UDN group 1 114A, the controller 110 may determine that the one or more policies may include traffic containment policies such that the first data packet(s) and/or any data packet(s) that include flowlabel1 associated with UDN group 1 114A are sent only to the device(s) included in UDN group 1 114A.

In some example, the controller 110 may identify second policies associated with UDN group 2 using UDN-ID-2. In some examples, such as where the controller 110 determines that a destination device of the second data packet(s) is included in the device(s) of UDN group 2 114B, the controller 110 may determine that the one or more policies may include traffic containment policies such that the second data packet(s) and/or any data packet(s) that include flowlabel2 associated with UDN group 2 114B are sent only to the device(s) included in UDN group 2 114B.

At 222, the controller 110 may send data traffic with flowlabel1 to device(s) in UDN Group 1 114A. For instance, the controller 110 may enforce segmentation of the data traffic based on the policies associated with UDN-ID-1, such that the first data packet(s) are only sent to the device(s) in UDN Group 1.

At 224, the controller 110 may send data traffic with flowlabel2 to device(s) in UDN Group 2 114B. For instance, the controller 110 may enforce segmentation of the data traffic based on the policies associated with UDN-ID-2, such that the second data packet(s) are only sent to the device(s) in UDN Group 2.

Accordingly, by utilizing flowlabel-to-application mappings, a user device can participate in multiple UDN groups at the same time without having to leave and/or rejoin group(s). Moreover, by only sending traffic to device(s) within a particular UDN group, network traffic is streamlined, without having to leave and/or rejoin a group.

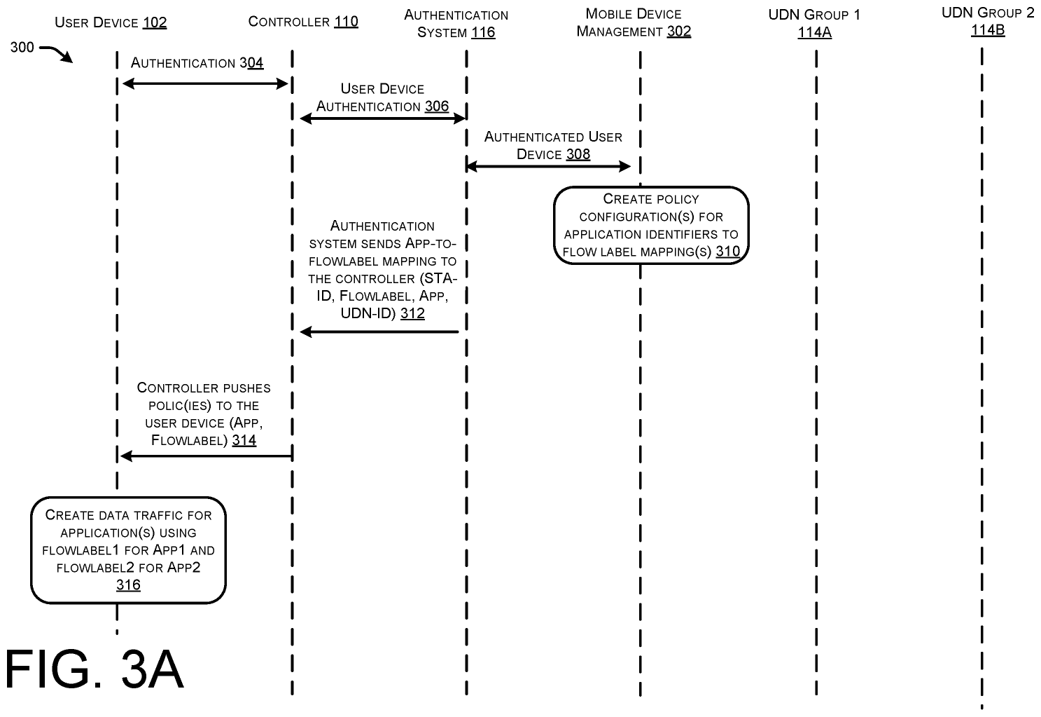

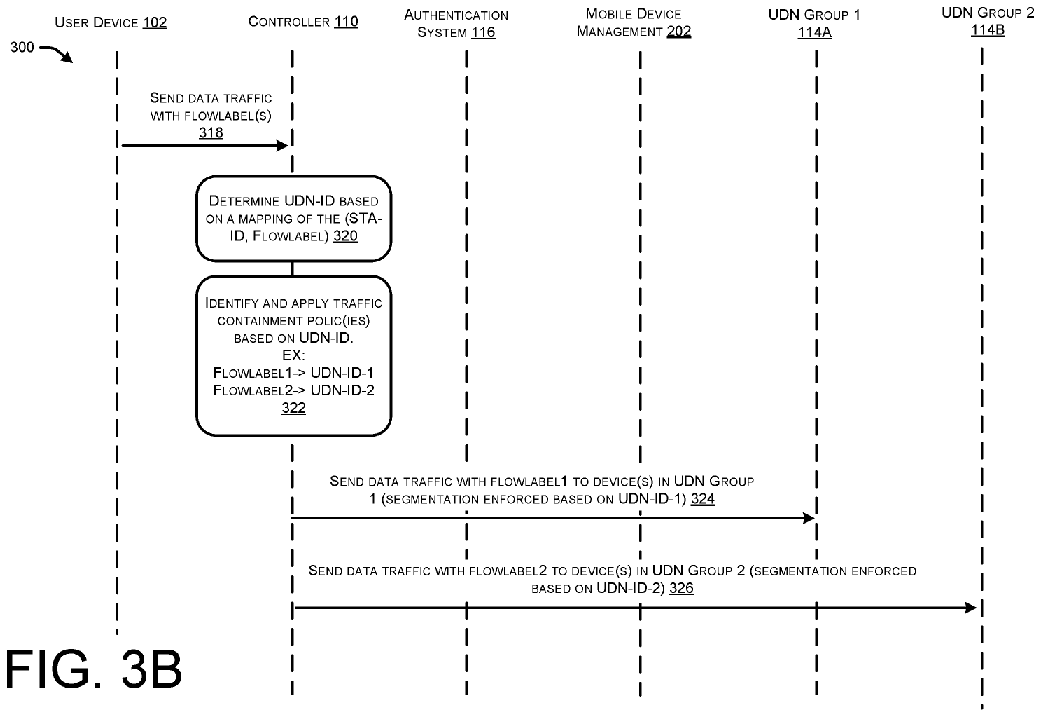

FIGS. 3A and 3B illustrate a flow diagram 300 of example communications corresponding to enabling an endpoint to have concurrent access to multiple private UDN groups. For instance, the controller may correspond to controller 110 described above. The user device may correspond to user device 102 described above. As described above, the controller 110 may comprise a WLC and/or an access point.

For instance, the endpoint may correspond to user device 102 described above. As illustrated, the system may include a mobile device management (MDM 302). As noted above, the mobile device management (MDM 302) may correspond to a functionality. For instance, the MDM 302 may create policy configuration(s) that include the application to flowlabel mapping(s). In some examples, the mobile device management may correspond to a network device 108 and/or an application or functionality executing on the network device 108 and/or the authentication system 116.

In some examples, the user of the user device may correspond to a student attempting to access private UDN group(s) the user has created within a school network. In this example, the UDN groups 114 may be included as part of the UDN cloud 112 described above. In some examples, the UDN groups 114 may be associated with groups of device(s) of the user. For instance, UDN group 1 114A may correspond to gaming device(s) (e.g., gaming console, TV, etc.) and UDN group 2 114B may correspond to school device(s) (e.g., laptop, printer, etc.).

As illustrated in FIG. 3A, at 304, the user device 102 may perform authentication with the controller 110. For instance, as described above, the user device 102 may send primary and/or secondary credentials to the controller 110 in order to access a network 106, create UDN group(s), and/or join a UDN group. For instance, the user device authentication may include performing EAP dialogue(s) with the user device.

At 306, the controller 110 may perform user device authentication with the authentication system 116. For instance, the controller 110 may authenticate the credential(s) provided by the user device 102.

As noted above, in some examples, the authentication system 116 may correspond to an external entity that manages only secondary credentials and/or secondary authentication of the user device. For instance, a first authentication system (e.g., such as an AAA engine) may handle primary access authentication of the user device at 216 and a second authentication system (e.g., such as an external entity), may handle the secondary authentication associated with the UDN group(s).

At 308, the authentication system 116 may send an indication that the user device 102 has been authenticated to the MDM 202. In some examples, the indication may comprise data including a device identifier of the user device 102, application identifier(s), UDN group identifier(s), etc.

At 310, the MDM 202 may create policy configuration(s) for application identifiers to flowlabel mapping(s). For instance, the MDM may create traffic enforcement polic(ies) associated with UDN group 1 114A and/or UDN group 2 114B. In some examples, the MDM 202 may generate flowlabel(s) and may map the flowlabel(s) to corresponding application(s) and UDN group(s). The MDM 202 may store the mapping(s) in memory and/or a server of the authentication system. In some examples, the MDM 202 updates a list of authenticated device(s) associated with UDN group 1 114A to include the user device 102 and/or updates the list of authenticated device(s) associated with UDN group 2 114B to include the user device 102.

At 312, the authentication system 116 may send the application-to-flowlabel mapping(s) to the controller 110. For instance, the authentication system 116 may send data including mapping(s) comprising a device identifier (e.g., STA-ID), flowlabel(s), application identifier(s), and/or UDN-ID(s)). As noted above, in some examples, the MDM 302 is part of the authentication system 116. In this example, the authentication system 116 may access the mapping(s) from a server of the authentication system 116 and/or from memory.

At 314, the controller may push polic(ies) to the user device 102. In some examples, the polic(ies) comprise the application-to-flowlabel mapping(s). For instance, the the application-to-flowlabel mapping(s) may comprise application identifier(s) and associated flowlabel(s). For instance, the controller 110 may push a first mapping comprising a first application identifier and a first flowlabel. The controller 110 may push a second mapping comprising a second application identifier and a second flowlabel. In some examples, the controller 110 may push a data packet that comprises a plurality of mapping(s) between a plurality of application(s) and a plurality of flowlabel(s). In some examples, the user device 102 may store the flowlabel-to-application mapping(s) in memory.

At 316, the user device 102 may create data traffic for application(s) using flowlabel1 for application1 and flowlabel2 for application2. For instance, the user device 102 may create first data packets associated with the use of application1. Application1 may correspond to application 104A described above and may be associated with accessing UDN group 1 114A. The user device 102 may also create second data packets associated with the use of application2. Application2 may correspond to application 104B described above and may be associated with accessing UDN group 1 114B. The first data packets may comprise flowlabel1 and the second data packets may comprise flowlabel2. In some examples, flowlabel1 and flowlabel2 are different. In some examples, the user device 102 creates the first data packets based at least in part on accessing an application-to-flowlabel mapping for application1 and application2. For instance, the user device 102 may access a first application identifier associated with application1 and the corresponding flowlabel1 from memory.

As illustrated in FIG. 3B, at 318, the user device 102 may send the data traffic with the flowlabel(s) to the controller 110. As described above, the data traffic may comprise first data packets associated with use of a first application and/or second data packets associated with use of a second application.

At 320, the controller 110 may determine a UDN-ID based on a mapping of a device identifier and flowlabel(s) included in the data traffic. For instance, the mapping may indicate a device identifier (e.g., STA-ID) and flowlabel1. Based on the mapping, the controller 110 may determine that the first data packets are destined for UDN-ID-1 (e.g., UDN group 1). For instance, a second mapping may indicate the device identifier (e.g., STA-ID) and flowlabel2. Based on the second mapping, the controller 110 may determine that the second data packets are destined for UDN-ID-2 (e.g., UDN group 2).

At 322, the controller 110 may identify and apply traffic containment policies based on UDN-ID(s). For instance, the controller 110 may identify one or more policies associated with UDN group 1 114A based on the UDN-ID-1. For instance, the one or more policies may include determining that the first data packet(s) are being sent to a device that is included in UDN group 1. Where the destination device is not included in UDN group 1, the controller 110 may refrain from sending the first data packet(s) to the device(s) included in UDN group 1 114A. For instance, the controller 110 may store list(s) of authenticated device(s) and corresponding UDN group(s) in memory. In some examples, such as where the destination device is included in the device(s) of UDN group 1 114A, the controller 110 may determine that the one or more policies may include traffic containment policies such that the first data packet(s) and/or any data packet(s) that include flowlabel1 associated with UDN group 1 114A are sent only to the device(s) included in UDN group 1 114A.

In some examples, the controller 110 may identify second policies associated with UDN group 2 using UDN-ID-2. In some examples, such as where the controller 110 determines that a destination device of the second data packet(s) is included in the device(s) of UDN group 2 114B, the controller 110 may determine that the one or more policies may include traffic containment policies such that the second data packet(s) and/or any data packet(s) that include flowlabel2 associated with UDN group 2 114B are sent only to the device(s) included in UDN group 2 114B.

At 324, the controller 110 may send data traffic with flowlabel1 to device(s) in UDN Group 1 114A. For instance, the controller 110 may enforce segmentation of the data traffic based on the policies associated with UDN-ID-1, such that the first data packet(s) are only sent to the device(s) in UDN Group 1.

At 326, the controller 110 may send data traffic with flowlabel2 to device(s) in UDN Group 2 114B. For instance, the controller 110 may enforce segmentation of the data traffic based on the policies associated with UDN-ID-2, such that the second data packet(s) are only sent to the device(s) in UDN Group 2.

Accordingly, by utilizing flowlabel-to-application mappings, a user device can participate in multiple UDN groups at the same time without having to leave and/or rejoin group(s). Moreover, by only sending traffic to device(s) within a particular UDN group, network traffic is streamlined, without having to leave and/or rejoin a group.

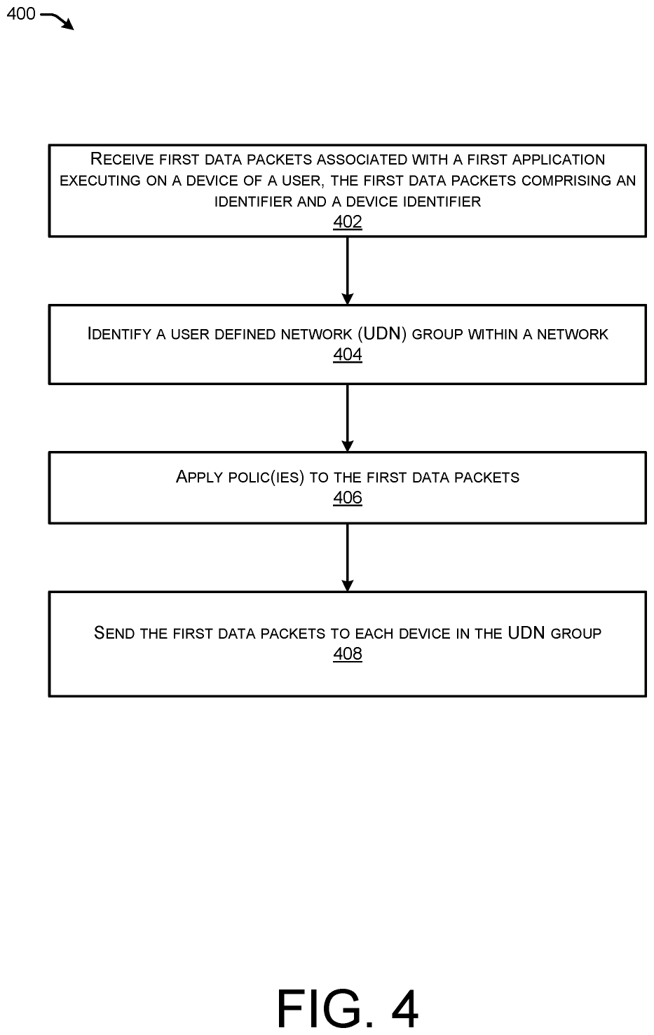

FIG. 4 illustrates a flow diagram of an example method 400 for a system to enable concurrent access to multiple private UDN groups. In some instances, the techniques may be performed by a system (e.g., one or more devices), such as the controller 110, network device 108, UDN cloud 112, authentication system(s) 116, a combination thereof, and/or any other devices (e.g., hardware offload chips and/or any other device). The techniques of method 400 may be performed by a system that includes one processor, or more than one processor.

At 402, the system may receive first data packets associated with a first application executing on a device of a user, the first data packets comprising an identifier and a device identifier. In some examples, the first data packets comprise identifier(s) 118 described above. In some examples, the first identifier comprises a flowlabel. In some examples, identifying the first UDN group within the network is based at least in part on identifying a mapping of the device identifier and the flowlabel to the first UDN identifier of the first UDN group.

In some examples, prior to receiving the first data packets, the system may receive a request to connect to the network from the device of the user, the request including credentials. In some examples, the system may authenticate the credentials. In some examples, the system may grant access to the network to the device.

In some examples, prior to receiving the first data packets, the system may receive, from an authentication, accounting, and authorization engine, data indicating a mapping of the first application to the first identifier associated with the first UDN group. In some examples, the system may store the mapping in memory. In some examples, the system may send, to the device of the user, the data indicating the mapping.

At 404, the system may identify a user defined network (UDN) group within a network. In some examples, the system may identify the UDN group based at least in part on the identifier. In some examples, the UDN group may comprise one or more second devices of the user.

At 406, the system may apply polic(ies) to the first data packets. In some examples, the polic(ies) may be based on the first UDN identifier. In some examples, the polic(ies) may comprise traffic enforcement and containment policies as described above.

In some examples, applying the one or more policies may comprise identifying, based at least in part on first UDN identifier of the first UDN group, a traffic enforcement policy associated with the first UDN group. In this example, the system may determine based at least in part on the first UDN identifier, that a destination of the first data packets corresponds to at least one of the one or more second devices. The system may send, based at least in part on the destination corresponding to at least one of the one or more second devices, the first data packets.

In some examples, applying the one or more policies comprises identifying, based at least in part on the first UDN identifier of the first UDN group, a traffic enforcement policy associated with the first UDN group. In this example, the system may determine, based at least in part on the first UDN identifier, that a destination of the first data packets does not correspond to at least one of the one or more second devices and refrain from sending the first data packets to the one or more second devices.

At 408, the system may send the first data packets to each device in the UDN group. For instance, as described above, the system may segment data traffic using the flowlabel and the first UDN identifier, such that the first data packets are sent only to the device(s) included in the UDN group.

In some examples, the system may receive, from the device of the user, second data packets associated with a second application executing on the device, the second data packets comprising a second identifier and a second device identifier. The system may identify, based at least in part on the second identifier, a second UDN group within the network, the second UDN group comprising one or more third devices of the user. The system may apply, based at least in part on a second UDN identifier associated with the second UDN group, one or more second policies to the second data packets. The system may send, based at least in part on the one or more second policies, the second data packets to each of the one or more third devices in the second UDN group. In some examples, the first application and the second application correspond to different applications, and the first identifier and the second identifier comprise different flowlabels.

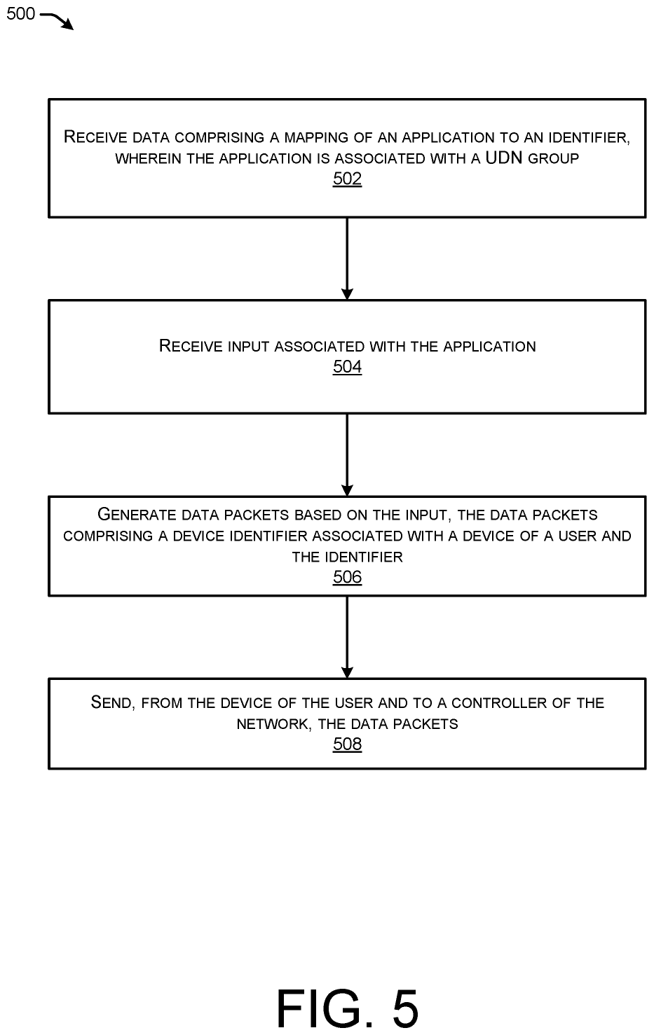

FIG. 5 illustrates a flow diagram of an example method 500 for a device to access multiple private UDNs concurrently. In some instances, the steps of method 500 may be performed by a device (e.g., user device 102) that includes one or more processors and one or more non-transitory computer-readable media storing computer-executable instructions that, when executed by the one or more processors, cause the one or more processors to perform operations of method 500.

At 502, the device may receive data comprising a mapping of an application to an identifier, wherein the application is associated with a UDN group. In some examples, the data is received from one of a mobile device management system of a network or a controller of the network. For instance, the mobile device management system may correspond to the MDM 202, 302 described above. The controller may correspond to the controller 110 described above. In some examples, the network comprises at least one of a wireless network, a cellular network, an enterprise network, or a private network.

At 504, the device may receive input associated with the application. For instance, a user of the device may provide input to send data to a UDN group within the network. As described above, a user may create multiple UDN groups within a network, where each UDN group includes a set of device(s) of the user.

At 506, the device may generate data packets based on the input, the data packets comprising a device identifier associated with a device of the user and the identifier. For instance, the device identifier may comprise a MAC address, a SSID, etc.

At 508, the device may send, from the device of the user and to a controller of the network, the data packets. In some examples, the device may receive second data, the second data comprising a second mapping of a second application to a second identifier, wherein the second application is associated with a second UDN group, and wherein the second identifier is different from the identifier. The device may receive second input associated with the second application. The device may generate, based at least in part on the second input, second data packets, the second data packets comprising the device identifier and the second identifier. The device may send, to the controller of the network, the second data packets. In some examples, the first data packets and the second data packets may be sent to the controller as part of the same data traffic.

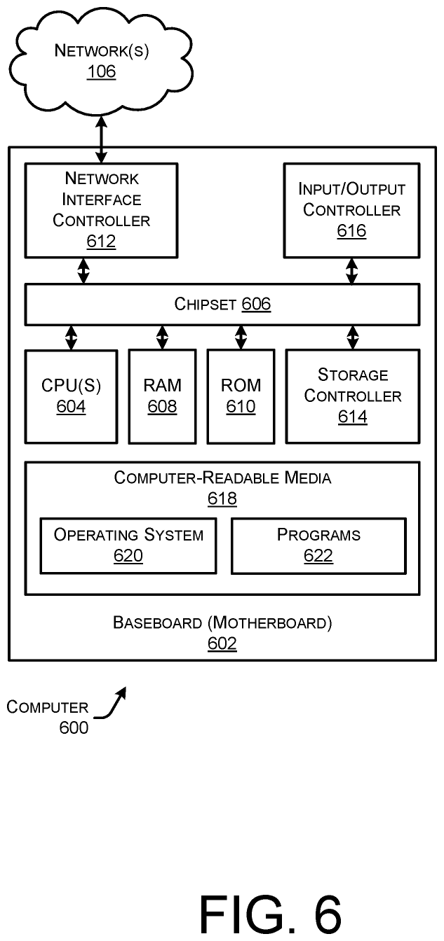

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a controller 110, network device 108, UDN cloud 112, authentication system(s) 116, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network(s) 106. The chipset 606 can include functionality for providing network connectivity through a NIC 612, such as a gigabit Ethernet adapter. The NIC 612 is capable of connecting the computer 600 to other computing devices over the network(s) 106. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the controller 110, network device 108, UDN cloud 112, authentication system(s) 116, and/or any components included therein, may be supported by one or more devices similar to computer 600. Stated otherwise, some or all of the operations performed by the controller 110, network device 108, UDN cloud 112, authentication system(s) 116, and or any components included therein, may be performed by one or more computers 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a controller 110, network device 108, UDN cloud 112, authentication system(s) 116, and/or any other device. The computer 600 may include one or more hardware processors (e.g., such as CPUs 604 (processors)) configured to execute one or more stored instructions. The processor(s) may comprise one or more cores. Further, the computer 600 may include one or more network interfaces configured to provide communications between the computer 600 and other devices, such as the communications described herein as being performed by the controller 110, network device 108, UDN cloud 112, authentication system(s) 116, and/or any other device. The network interfaces may include devices configured to couple to personal area networks (PANs), user defined networks (UDNs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for performing UDN service authorization based on secondary identity credentials. For instance, the programs 622 may cause the computer 600 to perform techniques including receiving, from a device of a user, first data packets associated with a first application executing on the device, the first data packets comprising a first identifier and a device identifier. In some examples, the techniques include identifying, based at least in part on the first identifier, a first user defined network (UDN) group within the wireless network, the first UDN group comprising one or more second devices of the user. In some examples, the techniques further include applying, based at least in part on a first UDN identifier associated with the first UDN group, one or more policies to the first data packets. The techniques may also include sending, based at least in part on the one or more policies, the first data packets to each of the one or more second devices in the first UDN group.

Additionally, or alternatively the programs 622 may cause the computer 600 to perform techniques including: receiving first data, the first data comprising a first mapping of a first application to a first identifier, wherein the first application is associated with a first UDN group. The techniques may include receiving first input associated with the first application. Based on receiving the first input, the techniques may include generating first data packets, the first data packets comprising a device identifier associated with the device and the first identifier. The techniques may further include sending, to a controller of the network, the first data packets.

In this way, an end user may be part of two or more private groups at the same time. By not having to leave a first UDN group and join a second UDN group, the current techniques improve UDN infrastructure and reduce network usage, improving the functioning of the network. Moreover, by only sending traffic to device(s) within a particular UDN group, network traffic is streamlined. Further, the techniques described herein enable access to the private group (e.g., UDN group) to be based on application. This enables users to have application based segmentation and enables the network infrastructure to enforce different application based policies and SLAs accordingly. Additionally, the techniques described herein provide users the ability to have disjoint set of groups (destinations) depending on which application is being used.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by a controller of a network, the method comprising:
receiving, from a device of a user, first data packets associated with a first application executing on the device, the first data packets comprising a first identifier and a device identifier;
identifying, based at least in part on the first identifier, a first user defined network (UDN) group within the network, the first UDN group comprising one or more second devices of the user;
applying, based at least in part on a first UDN identifier associated with the first UDN group, one or more policies to the first data packets; and
sending, based at least in part on the one or more policies, the first data packets to each of the one or more second devices in the first UDN group.

2. The method of claim 1, wherein prior to receiving the first data packets, the method further comprising:
receiving, from an authentication, accounting, and authorization engine, data indicating a mapping of the first application to the first identifier associated with the first UDN group;
storing the mapping in memory; and
sending, to the device of the user, the data indicating the mapping.

3. The method of claim 1, wherein prior to receiving the first data packets, the method further comprising:
receiving a request to connect to the network from the device of the user, the request including credentials;
authenticating the credentials; and
granting access to the network to the device.

4. The method of claim 1, wherein the first identifier comprises a flowlabel, and wherein identifying the first UDN group within the network is based at least in part on identifying a mapping of the device identifier and the flowlabel to the first UDN identifier of the first UDN group.

5. The method of claim 1, wherein applying the one or more policies comprises:
identifying, based at least in part on first UDN identifier of the first UDN group, a traffic enforcement policy associated with the first UDN group;
determining, based at least in part on the first UDN identifier, that a destination of the first data packets corresponds to at least one of the one or more second devices; and
sending, based at least in part on the destination corresponding to at least one of the one or more second devices, the first data packets.

6. The method of claim 1, wherein applying the one or more policies comprises:
identifying, based at least in part on the first UDN identifier of the first UDN group, a traffic enforcement policy associated with the first UDN group;
determining, based at least in part on the first UDN identifier, that a destination of the first data packets does not correspond to at least one of the one or more second devices; and
refraining from sending the first data packets to the one or more second devices.

7. The method of claim 1, further comprising:
receiving, from the device of the user, second data packets associated with a second application executing on the device, the second data packets comprising a second identifier and a second device identifier;
identifying, based at least in part on the second identifier, a second UDN group within the network, the second UDN group comprising one or more third devices of the user;
applying, based at least in part on a second UDN identifier associated with the second UDN group, one or more second policies to the second data packets; and
sending, based at least in part on the one or more second policies, the second data packets to each of the one or more third devices in the second UDN group.

8. The method of claim 7, wherein the first application and the second application correspond to different applications, and wherein the first identifier and the second identifier comprise different flowlabels.

9. A system comprising:
one or more processors; and
one or more non-transitory computer-readable media storing computer-executable instructions that, when executed by the one or more processors, cause the one or more processors to perform operations comprising:
receiving, from a device of a user of a network, first data packets associated with a first application executing on the device, the first data packets comprising a first identifier and a device identifier;
identifying, based at least in part on the first identifier, a first user defined network (UDN) group within the network, the first UDN group comprising one or more second devices of the user;
applying, based at least in part on a first UDN identifier associated with the first UDN group, one or more policies to the first data packets; and
sending, based at least in part on the one or more policies, the first data packets to each of the one or more second devices in the first UDN group.

10. The system of claim 9, wherein prior to receiving the first data packets, the operations further comprising:
receiving, from an authentication, accounting, and authorization engine, data indicating a mapping of the first application to the first identifier associated with the first UDN group;
storing the mapping in memory; and
sending, to the device of the user, the data indicating the mapping.

11. The system of claim 9, wherein prior to receiving the first data packets, the operations further comprising:
receiving a request to connect to the network from the device of the user, the request including credentials;
authenticating the credentials; and
granting access to the network to the device.

12. The system of claim 9, wherein the first identifier comprises a flowlabel, and wherein identifying the first UDN group within the network is based at least in part on identifying a mapping of the device identifier and the flowlabel to the first UDN identifier of the first UDN group.

13. The system of claim 9, wherein applying the one or more policies comprises:
identifying, based at least in part on first UDN identifier of the first UDN group, a traffic enforcement policy associated with the first UDN group;
determining, based at least in part on the first UDN identifier, that a destination of the first data packets corresponds to at least one of the one or more second devices; and
sending, based at least in part on the destination corresponding to at least one of the one or more second devices, the first data packets.

14. The system of claim 9, wherein applying the one or more policies comprises:
identifying, based at least in part on the first UDN identifier of the first UDN group, a traffic enforcement policy associated with the first UDN group;
determining, based at least in part on the first UDN identifier, that a destination of the first data packets does not correspond to at least one of the one or more second devices; and
refraining from sending the first data packets to the one or more second devices.

15. The system of claim 9, the operations further comprising:
receiving, from the device of the user, second data packets associated with a second application executing on the device, the second data packets comprising a second identifier and a second device identifier;
identifying, based at least in part on the second identifier, a second UDN group within the network, the second UDN group comprising one or more third devices of the user;
applying, based at least in part on a second UDN identifier associated with the second UDN group, one or more second policies to the second data packets; and
sending, based at least in part on the one or more second policies, the second data packets to each of the one or more third devices in the second UDN group.

16. The system of claim 15, wherein the first application and the second application correspond to different applications, and wherein the first identifier and the second identifier comprise different flowlabels.

17. A method implemented at least in part by a device of a user of a network, the method comprising:
receiving first data, the first data comprising a first mapping of a first application to a first identifier;
receiving first input associated with the first application;
generating, based at least in part on the first input associated with the first application, first data packets, the first data packets comprising a device identifier associated with the device and the first identifier; and
sending, to a controller of the network, the first data packets.

18. The method of claim 17, further comprising:
receiving second data, the second data comprising a second mapping of a second application to a second identifier, and wherein the second identifier is different from the first identifier;
receiving second input associated with the second application;
generating, based at least in part on the second input, second data packets, the second data packets comprising the device identifier and the second identifier; and
sending, to the controller of the network, the second data packets.

19. The method of claim 17, wherein the first data is received from one of a mobile device management system of the network or the controller of the network.

20. The method of claim 17, wherein the network comprises at least one of a wireless network, a cellular network, an enterprise network, or a private network.
